(19) United States
(12) Patent Application Publication
(10) Pub. No.: US 2025/0392645 A1
(43) Pub. Date: Dec. 25, 2025

(54) SYSTEM AND METHOD FOR TRANSMITTING USER LOCATION OF USER EQUIPMENT TO CORE NETWORK

(71) Applicant: JIO PLATFORMS LIMITED, Ahmedabad, Gujarat (IN)

(72) Inventors: Arpan NANDA, Navi Mumbai, Maharashtra (IN); Barid Baran NAYAK, Bhubaneswar, Odisha (IN); Bibekananda JENA, Navi Mumbai, Maharashtra (IN); Bhupinder SINGH, Mandi Dabwali, Haryana (IN); Jim J. EDAKKARA, Thrissur, Kerala (IN); Koushik MUKHERJEE, Behala, Kolkata, West Bengal (IN); Nikihil KUMTHEKAR, Navi Mumbai, Maharashtra (IN); Shashi SHEKHAR, Dist-Supaul, Bihar (IN)

(73) Assignee: JIO PLATFORMS LIMITED, Ahmedabad, Gujarat (IN)

(21) Appl. No.: 18/881,371

(22) PCT Filed: Dec. 23, 2023
(86) PCT No.: PCT/IB2023/063212

§ 371 Date: Jan. 6, 2025

(30) Foreign Application Priority Data
Dec. 26, 2022 (IN) 202221075624

(51) Int. Cl. H04L 67/141; H04W 4/029; H04W 64/00; H04W 76/12

(52) U.S. Cl. CPC H04L 67/141; H04W 4/029; H04W 64/00; H04W 76/12

(57) ABSTRACT

The present disclosure provides a system (104) and a method (400) for transmitting user location of User Equipment (UEs) (102) to core network (116), where the UEs (102) connect to the core network (116) via a network entity (118) associated with an external network. The system (104) retrieves user location, such as New Radio Cell Global Identity (NCGI) and Fifth-generation Tracking Area Identity (5G-TAI), from an Access and Management Function (AMF) (110). Further, the system (104) transmits the user location in User Location Information (ULI) Information Element (IE) by appending the NCGI and 5G-TAI thereto. A Session Management Function (SMF) (112) transmits the user location to a Policy Charging Function (PCF) (114), and create a session based on one or more applicable policy and charging rules determined by the PCF (114).

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The embodiments of the present disclosure generally relate to telecommunications network. More particularly, the present disclosure relates to a system and a method for transmitting a 5G Tracking Area Identifier (5G-TAI) and New Radio (NR) Cell Global Identifier (NCGI) information to a core network over General Packet Radio Service (GPRS) Tunneling Protocol version 2 (GTPv2) protocol.

### BACKGROUND

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

The Third-Generation Partnership Project (3GPP) defines New Radio Cell Global Identifier (NCGI) and Fifth-generation Tracking Area Identifier (5G-TAI) to identify the gNodeB (gNB) tower and its corresponding cell serving a 5G user. Since the gNodeB is fixed, user location is known from the NCGI and the 5G-TAI information to which the user is attached. On external networks, specifically non-3GPP networks, there is no way to identify the location of the user. For example, in Voice-over Wireless Fidelity (VoWiFi) applications, the User Equipment (UE) may not be able to provide the NCGI and the 5G-TAI to the core network and accordingly create sessions through a session management function packet gateway (SMF+PGW-C), which may create sessions based on one or more policy and charging rules determined by a Policy Control Function (PCF) based on the UE's location.

In existing architectures, evolved packet data gateway (ePDG) or Trusted Wireless Local Area Network (WLAN) Access Gateway, through which UEs from external networks may request services from the core network, are incapable of transmitting the 5G-TAI and the NCGI information to SMF+PGW-C, as there exist no provision in the standards for the same. Hence the user location information is not forwarded to the PCF for applying operator policies based on location.

There is, therefore, a need for a system and a method that can mitigate the problems associated with the prior arts, and allow transmission of user location of UEs connected to the core network from external networks.

### OBJECTS OF THE PRESENT DISCLOSURE

Some of the objects of the present disclosure, which at least one embodiment herein satisfies are listed herein below.

It is an object of the present disclosure to provide a system and a method that transmits a New Radio (NR) Cell Global Identifier (NCGI) and Fifth-generation Tracking Area Identity (5G-TAI) to a core network.

It is an object of the present disclosure to transmit user location information using a general packet radio service (GPRS) tunnelling protocol version 2 (GTPv2).

It is an object of the present disclosure to enable an evolved-Packet Data Gateway (ePDG) or Trusted Wireless Local Area Network (WLAN) Access Gateway (TWAN) to provide user location information to Policy Control Function (PCF) via Session Management Function (SMF).

It is an object of the present disclosure to enable PCF to determine policies based on NCGI and 5G-TAI.

It is an object of the present disclosure to provide UEs connected through external networks with services of the core network.

### SUMMARY

Aspects of the present disclosure generally relate to telecommunications. More particularly, the present disclosure relates to a system and a method for transmitting a 5G Tracking Area Identifier (5G-TAI) and New Radio (NR) Cell Global Identifier (NCGI) information to a core network.

In an aspect, a system for transmitting user location of User Equipment (UEs) over a core network includes one or more processors, and a memory operatively coupled to the one or more processors, the memory having one or more processor-executable instructions. Execution of the processor-executable instructions cause the one or more processors to UEs receive a request for a service provided by a core network from one or more UEs. The one or more UEs are connected to the core network via a network entity associated with an external network. The one or more processors may transmit a session creation request to a Session Management Function (SMF), where the session creation request may include New Radio (NR) Cell Global Identifier (NCGI) and a Fifth-generation Tracking Area Identifier (5G-TAI) appended to a User Location Information (ULI) Information Element (IE) transmitted through the session creation request. The one or more processors may receive a session creation response from the SMF indicating the creation of a session, where the SMF creates the session for enabling communication between the one or more UEs and the core network via the network entity based on the NCGI and the 5G-TAI.

In some embodiments, the one or more processors may be configured to retrieve the 5G-TAI and the NCGI from an Access Management Function (AMF) of the core network.

In some embodiments, to retrieve the 5G-TAI and the NCGI from the AMF, the one or more processors may be configured to transmit an Authentication and Authorization (AA) request to an Authentication, Authorization and Accounting (AAA) server to request for the 5G-TAI and NCGI of each of the one or more UEs. In response to the AA request, the AAA server may transmit a User Data Request (UDR) to a user database server of the core network for requesting the 5G-TAI and the NCGI of each of the one or more UEs, and may receive a User Data Answer (UDA) having the requested 5G-TAI and the NCGI from the user database server. In response to the UDR, the user database server may transmit a network exposure request to the AMF, and may receive a network exposure response having the 5G-TAI and the NCGI of each of the one or more UEs from the AMF. The one or more processors may be configured to receive the 5G-TAI and the NCGI of each of the one or more UEs from the AAA server.

In some embodiments the SMF may create the session based on one or more policy and charging rules determined to be applicable by a Policy and Charging Function (PCF). The PCF determines the one or more policy and charging rules based on the 5G-TAI and the NCGI provided by the system.

In an aspect, a method for transmitting user location of User Equipment (UEs) over a core network may include receiving, by a system, a request for service from the one or more User Equipment (UEs) for a service provided by a core network, where the UEs connected to the core network via a network entity associated with an external network. The method includes transmitting, by the system, a session creation request to a Session Management Function (SMF), where the session creation request may include New Radio (NR) Cell Global Identifier (NCGI) and a Fifth-generation Tracking Area Identifier (5G-TAI) appended to a User Location Information (ULI) Information Element (IE) transmitted through the session creation request. The method includes receiving, by the system, a session creation response from the SMF indicating the creation of a session, where the SMF creates the session for enabling communication between the one or more UEs and the core network via the network entity based on the NCGI and the 5G-TAI.

In some embodiments, the method may include retrieving, by the system, the 5G-TAI and the NCGI from an Access Management Function (AMF) of the core network.

In some embodiments, for retrieving the 5G-TAI and the NCGI, the method may include transmitting, by the system, an Authentication and Authorization (AA) request to an Authentication, Authorization, and Accounting (AAA) server. In response to the AA request, the AAA server may transmit a User Data Request (UDR) to a user database server of the core network for requesting the 5G-TAI and the NCGI of each of the one or more UEs, and may receive a User Data Answer (UDA) having the requested 5G-TAI and the NCGI from the user database server. In response to the UDR, the user database server may transmit a network exposure request to the AMF, and may receive a network exposure response having the 5G-TAI and the NCGI for each of the one or more UEs from the AMF. The method may include receiving, by the system, an AA answer having the 5G-TAI and the NCGI for each of the one or more UEs from the AAA server.

In some embodiments, the SMF may create a session based on one or more policy and charging rules determined to be applicable by a Policy and Charging Function (PCF). The PCF determines the one or more policy and charging rules based on the 5G-TAI and the NCGI provided by the system.

In an aspect, a User Equipment (UE) device includes one or more processors, and a memory operatively coupled to the one or more processors, the memory having one or more processor-executable instructions. Execution of the one or more processor-executable instructions causes the one or more processors to transmit, via a network entity associated with an external network, a set of signals to a system for requesting a service provided by a core network. On receiving the request, the system may be configured to transmit a session creation request to a Session Management Function (SMF), where the session creation request may include New Radio (NR) Cell Global Identifier (NCGI) and a Fifth-generation Tracking Area Identifier (5G-TAI) appended to a User Location Information (ULI) Information Element (IE) transmitted through the session creation request, and receive a session creation response from the SMF indicating the creation of a session, where the SMF creates the session for enabling communication between the one or more UEs and the core network via the network entity based on the NCGI and the 5G-TAI. The UE device may use the session to communicate with the other UEs connected to the core network.

In an aspect, the present disclosure relates to a non-transitory computer-readable medium which may include processor-executable instructions that implement the system and the method of the present disclosure.

Various objects, features, aspects, and advantages of the inventive subject matter will become more apparent from the following detailed description of preferred embodiments, along with the accompanying drawing figures in which like numerals represent like components.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system, in accordance with embodiments of the present disclosure.

FIG. 2 illustrates an exemplary representation (200) of the system, in accordance with embodiments of the present disclosure.

FIG. 3 illustrates an exemplary format (300) of a User Location Information (ULI) Information Element (IE), in accordance with embodiments of the present disclosure.

FIG. 4 illustrates an exemplary flow diagram (400) of providing New Radio (NR) Cell Global Identifier (NCGI) And 5G Tracking Area Identifier (5G-TAI) information report in ULI IE, in accordance with embodiments of the present disclosure.

FIG. 5 illustrates an exemplary computer system (500) in which or with which the proposed system may be implemented, in accordance with embodiments of the present disclosure.

The foregoing shall be more apparent from the following more detailed description of the disclosure.

### BRIEF DESCRIPTION OF THE PRESENT DISCLOSURE

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

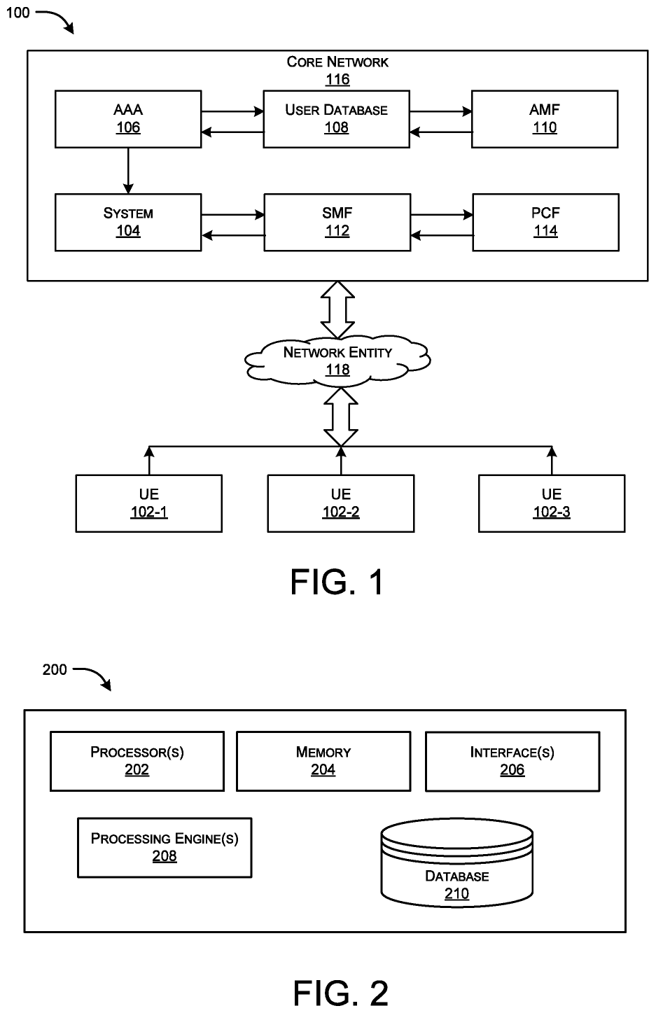

The various embodiments throughout the disclosure will be explained in more detail with reference to FIGS. 1-5.

FIG. 1 illustrates an exemplary network architecture (100), in accordance with embodiments of the present disclosure. As illustrated in FIG. 1, one or more computing devices/User Equipment (UE) (102-1, 102-2, 102-3) (collectively referred to as the UEs (102)) may be connected to a core network (116) via a network entity (118).

In some embodiments, the network entity (118) may facilitate communication between the core network (116) and the UEs (102). In some embodiments, the network entity (118) may allow the UEs (102) to avail services from the core network (116) through an external network. In some embodiments, the external network may be indicative of any one or combination of including, but not limited to, Local Area Network (LAN), Wireless Local Area Network (WLAN), Wide Area Network (WAN), Virtual Private Networks (VPN), Intranet, Extranet, and the like. In some embodiments, the external network may be a non-Third-Generation Partnership Project (3GPP) network. In an example, the network entity (118) may be an access point associated with a Wireless-Fidelity (Wi-Fi) network, but may not be limited thereto.

In some embodiments, the UE (102) may include, but not be limited to, a mobile, a laptop, a general-purpose computer, a desktop, a personal digital assistant, a tablet computer, a mainframe computer, a tablet, a phablet, a dongle, an Internet-of-Things (IoT) devices, drones, an electronic device, and the like. Further, the UEs (102) may include one or more in-built or externally coupled accessories including, but not limited to, a visual aid device such as a camera, audio aid, microphone, or keyboard. Additionally, input devices for receiving input from a user such as a touchpad, touch-enabled screen, electronic pen, and the like may be used. It may be appreciated that the terms “computing device” and “UE” may be used interchangeably throughout the disclosure. A user may use the UEs (102) to communicate with other users using UEs (102) connected to the core network (116). The services that may be availed by the UEs (102) from the core network (116) may include, but not limited to, voice calls, video calls, messaging, internet connectivity, and the like. Although three UEs (102) are depicted in FIG. 1, it may be appreciated that any number of UEs (102) may be implemented without departing from the scope of the present disclosure.

As shown in FIG. 1, the core network (116) may include one or more network functions, including, but not limited to, a system (104), an Authentication, Authorisation, Accounting (AAA) server (106), a user database server (108), an Access and Mobility Management Function (AMF) (110), a Session Management Function (SMF) (112), and a Policy Control Function (PCF) (114). The UEs (102) may establish a connection with the core network (116) through the network entity (118). The core network (116) may provide one or more services to the UEs (102), including, but not limited to, telecommunication services, among others, between one or more the UEs (102). In some embodiments, the one or more services may be provided through the transmission and reception of data packets between the UEs (102) and the core network (116). In an example, the core network (116) may allow two or more of the UEs (102) to establish a communication session therebetween through the network entity (118). In some embodiments, the core network (116) may be indicative of a 3GPP network, i.e. compliant with standards thereof. In some embodiments, the core network (116) may be indicative of one or more Radio Access Networks (RANs), such as a base station, associated with Radio Access Technologies (RATs) of Fifth-Generation (5G) and Fourth-Generation (4G), but not limited thereto. While FIG. 1 illustrates some of the network functions of the core network (116), it may be appreciated by those skilled in the art that the core network (116) may include, or more be adapted to include, other network functions not illustrated in FIG. 1 without deviating from the scope of the present disclosure.

In some embodiments, each of the network functions of the core network (116) may be implemented on a hardware component, or a software component, or a combination thereof. In some examples, the network functions may be implemented on a processor, a microcontroller, a digital signal processor, a central processing unit, an integrated circuit, or the like. In such examples, the network functions may be configured to execute one or more processor-executable instructions to perform a predetermined set of operations. The network functions may be communicatively coupled to transmit and receive requests from each other to allow the core network (116) to provide services to the UEs (102) through the network entity (118).

In some embodiments, the system (104) may offload network traffic on the core network (116) to the external network associated with the network entity (118). In some examples, the external network may be indicative of a non-3GPP network, such as a Voice-over-Wi-Fi (VoWiFi) network, and the like. In some embodiments, the system (104) may be indicative of an evolved-Packet Data Gateway (ePDG) or a Trusted Wireless Local Area Network (WLAN) Access Gateway (TWAG), but not limited thereto. The system (104) may allow the UEs (102) to avail services of the core network (116) while being connected to the external network. The system (104) may facilitate communication between the core network (116) and the UEs (102) to allow the UEs (102) to avail services from the core network (116). In some embodiments, the system (104) may communicate with the network functions of the core network (116) for authentication, session management, application of policy charging rules associated with each of the UEs (102) connected thereto, and the like.

In some embodiments, the system (104) may be configured to transmit a user location to one or more of the network functions of the core network (116). In some embodiments, the user location may be associated with the UEs (102) requesting service from the core network (116). The user location may include a New Radio (NR) Cell Global Identifier (NCGI) and a Fifth-generation Tracking Area Identifier (5G-TAI). In some embodiments, the 5G-TAI may be derived from Mobile Country Code (MCC), Mobile Network Code (MNC) and Tracking Area Code (TAC). In some embodiments, the system (104) may be configured to retrieve the 5G-TAI and the NCGI from an Access Management Function (AMF) (110) of the core network (116). In some embodiments, the system (104) may be configured to transmit the NCGI and the 5G-TAI in a User Location Information (ULI) Information Element (IE) to the corresponding network function. In some embodiments, the IE may be indicative of Attribute Value Pairs (AVP) based on formats accepted by communication protocols.

To retrieve the 5G-TAI and the NCGI from the AMF (110), the system (104) may transmit requests to the AMF (110) through the AAA server (106) and the user database server (108). In some embodiments, the AAA server (106) of the core network (116) may be configured to authenticate the UEs (102) requesting services from the core network (116) through the system (104). In some embodiments, the system (104) may transmit an Authentication and Authorization (AA) request to the AAA server (106). In some examples, the AA request may be a Diameter Extensible Authentication Protocol (EAP) Request (DER). In some embodiments, the AAA server (106) may be configured to, in response to receiving the AA request, transmit a User Data Request (UDR) to the user database server (108).

In some embodiments, the user database server (108) may store records of each of the UEs (102) subscribing services provided by the core network (116). In some embodiments, the user database server (108) may be indicative of a Home Subscriber Server (HSS), a Unified Data Management (UDM), or an HSS+UDM network function. In some embodiments, in response to the UDR, the user database server (108) transmits a network exposure request to the AMF (110)

In some embodiments, the AMF (110) may be configured to provide access control and mobility to the UEs (102), among other functionalities. In some embodiments, the AMF (110) may be configured to respond to the network functions requesting user location of the UEs (104) with the NCGI associated with the network entity (118). The UEs (102) may use the NCGI to request services from the core network (116). The AMF (110) may be configured to transmit the NCGI and the 5G-TAI of the UEs (102) to the network function requesting the user location. In some embodiments, the AMF (110) may respond with the NCGI and the 5G-TAI of the UEs (102) when an event exposure request, such a Namf_EventExposure request, is transmitted thereto. The event exposure request may be indicative of an Application Programming Interface (API) request. The AMF (110) may respond to the even exposure request with the NCGI and the 5G-TAI. The user database server (108) may receive the 5G-TAI and the NCGI for each of the UEs (102) from the AMF (110) in the network exposure response.

In some embodiments, the user database server (108) may transmit a User Data Answer (UDA) to the AAA server with the requested 5G-TAI and the NCGI. In some embodiments, the AAA server (106) receives the UDA having the requested 5G-TAI and the NCGI from the user database server (108). In some embodiments, the system (104) may receive the 5G-TAI and the NCGI of each of the one or more UEs (102) from the AAA server (106).

In some embodiments, the SMF (112) may be configured to create and terminate sessions between the UEs (102) and the network functions of the core network (116), among other functionalities. In some embodiments, the SMF (112) may manage data sessions with the UEs (102) to allow said UEs (102) to exchange data with the core network (116). In some embodiments, the SMF (112) may be configured to Packet Data Network Gateway (PGW-C) that provides an interface between the core network (116) and an external Internet Protocol (IP) network, such as the Internet.

In some embodiments, the system (104) may receive a request from the UEs (102) for a service provided by the core network (116). The system (104) may, on receiving the request for the service, transmit a session creation request to the SMF (112). The session creation request may include the NCGI and the 5G-TAI appended to the ULI IE transmitted through the session creation request. In some embodiments, the system (104) may receive a session creation response from the SMF (112) indicating the creation of a session. In such embodiments, the SMF (112) creates the session for enabling communication between the one or more UEs (102) and the core network (116) via the network entity (118) based on the NCGI and the 5G-TAI. Sessions between the UEs (102) and the core network (116) may allow for exchange of data packets, thereby allowing provision of services to the UEs (102).

In some embodiments, the PCF (114) may be configured to determine policy and charging rules applicable to the UEs (102) requesting service from the core network (116). In some embodiments, the PCF (114) may be provided with the ULI IE to allow the PCF (114) to infer the location of the UEs (102). In such embodiments, the PCF (114) may retrieve policy and charging rules applicable to the UEs (102) based on locations thereof. In some embodiments, the SMF (112) may receive the applicable policy and charging rules determined by the PCF (114). The SMF (112) may be configured to create a session based on the received policy and charging rules, and respond to the system (104) therewith.

In some examples, the system (104) may transmit the create session request through a General Packet Radio Service (GPRS) Tunnelling Protocol version 2 (GTPv2) to the SMF (112). In some embodiments, system (104) may transmit the NCGI and the 5G-TAI information to the PCF (114) through the SMF (112). The PCF (114) may return the applicable policy and charging rules to the UEs (102) based on the user location. Further, based on the policies, the SMF (112) may decide whether to allow or terminate the session and respond to the system (104) accordingly.

It may be appreciated that an exemplary embodiment of the present disclosure may be implemented for VoWiFi in 5G core for communication between ePDG and SMF+PGW-C network functions. The 5G-TAI and the NCGI information available with the ePDG may be forwarded to the SMF+PGW-C. In other exemplary embodiments, the system (104) may be used for communication between the S2a Mobility over GPRS Tunnelling Protocol (GTP) TWAG and SMF+PGW-C for data offload scenarios.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

In another aspect, a User Equipment (UE) device, such as the UEs (102) may include, one or more processors, and a memory operatively coupled to the one or more processors, the memory having one or more processor-executable instructions. Execution of the one or more processor-executable instructions cause the one or more processors to transmit, via a network entity associated with an external network, a set of signals to a system, such as the system (104) for requesting a service provided by a core network. On receiving the request, the system may be configured to, transmit a session creation request to a Session Management Function (SMF), such as the SMF (112), where the session creation request may include New Radio (NR) Cell Global Identifier (NCGI) and a Fifth-generation Tracking Area Identifier (5G-TAI) appended to a User Location Information (ULI) Information Element (IE) transmitted through the session creation request, and receive a session creation response from the SMF indicating the creation of a session. The SMF creates the session for enabling communication between the one or more UEs and the core network via the network entity based on the NCGI and the 5G-TAI. The UE device may use the session to communicate with the other UEs connected to the core network.

FIG. 2 illustrates an exemplary representation (200) of the system (104), in accordance with embodiments of the present disclosure. A person of ordinary skill in the art will understand that the system of FIG. 2 may be similar to the network entity of FIG. 1 in its functionality.

Referring to FIG. 2, the system may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system. The memory (204) may be configured to store one or more computer-readable instructions or routines in a non-transitory processor-readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system may include an interface(s) (206). The interface(s) (206) may comprise a variety of interfaces, for example, interfaces for data input and output devices, referred to as input/output (I/O) devices, storage devices, and the like. The interface(s) (206) may facilitate communication through the system. The interface(s) (206) may also provide a communication pathway for one or more components of the system. Examples of such components include, but are not limited to, processing engine(s) (208) and a database (210).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may include a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

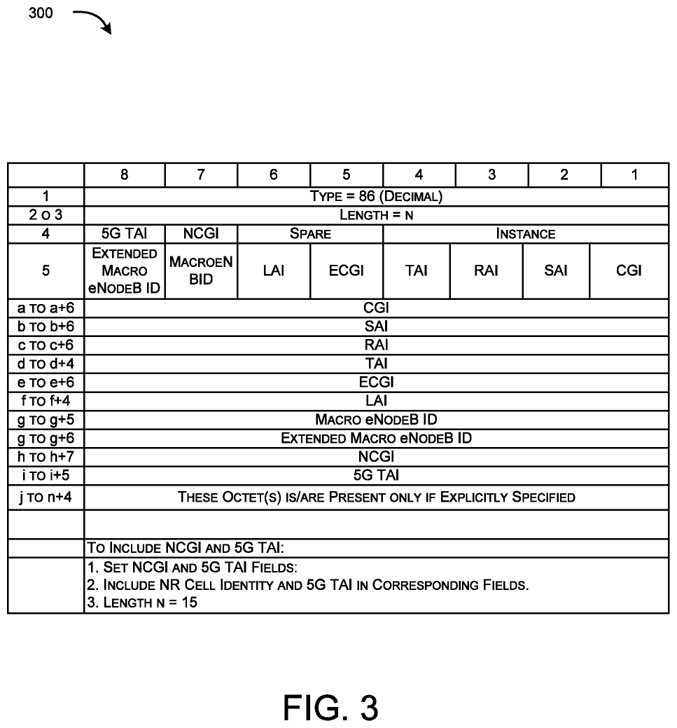

FIG. 3 illustrates an exemplary format (300) of the ULI IE, in accordance with embodiments of the present disclosure.

The 3GPP specification technical specification (TS) 29.274 defines user location information (ULI IE) in s2a and s2b interface for Sending Cell Global Identifier (CGI), Service Area Identifier (SAI), Routing Area Identification (RAI), Tracking Area Identity (TAI) indicative of legal generation TAIs, Extended Cell Global Identifier (ECGI), and Local Area Identity (LAI) which hold the access network information belonging to the network architecture (100) described in FIG. 1. In some embodiments, the system (104) may append the 5G-TAI and the NCGI to the ULI IE. In some examples, the system (104) may store the 5G-TAI and the NCGI in the spare field, such as 7^{th} or 8^{th} bit of the 4^{th} octet of the ULI IE. In an exemplary embodiment illustrated in FIG. 3, the 7^{th} bit may be used to store the NCGI, and the 8^{th} bit may be used to store the 5G-TAI, or vice-versa. The configuration described in FIG. 3 may be used by the system (104) or TWAG, and on the SMF (112). By accepting the NCGI and the 5F-TAI associated with the UEs (102) to be transmitted via the ULI IE, the UEs (102) may be able to avail services provided by the core network (116) from the external network. In some examples, using the NCGI and 5G-TAI of the UEs (102), the core network (116) may be able to provide those services that required locational information to the UEs (102).

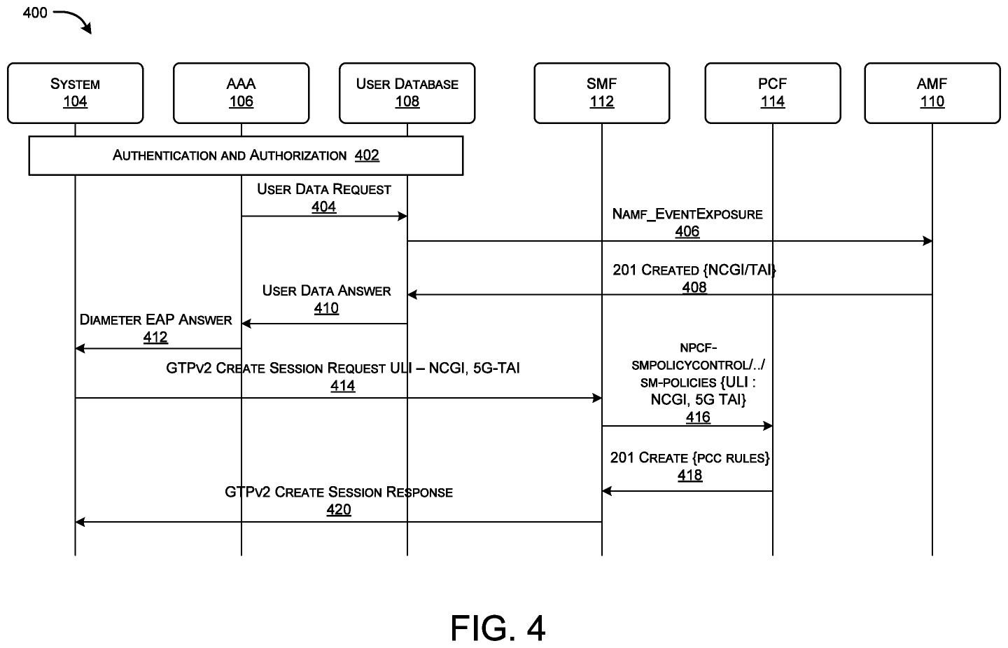

FIG. 4 illustrates an exemplary flow diagram (400) of providing the NCGI and the 5G-TAI in the ULI IE, in accordance with embodiments of the present disclosure.

At step (402), the method (400) may include transmitting, by a system (104), an Authentication and Authorization (AA) request to an Authentication, Authorization, and Accounting (AAA) server (106). In an example, the system (104) may transmit the AA request via a DER to the AAA server (106).

At step (404), the method (400) may include, in response to receiving the AA request, transmitting, by the AAA server (106), a User Data Request (UDR) to a user database server (108) for requesting user location, including, but not limited to, the New Radio (NR) Cell Global Identifier (NCGI) and a Fifth-generation Tracking Area Identifier (5G-TAI), of each of the one or more UEs (102).

At step (406), the method (400) may include, in response to the UDR request, transmitting, by the user database server (108), a network exposure request to an Access and Mobility (AMF) (110).

At step (408), the method (400) may include receiving, by the user database server (108), a network exposure response having the 5G-TAI and the NCGI for each of the one or more UEs (102) from the AMF (110).

At step (410), the method (400) may include receiving, by the AAA server (106), a User Data Answer (UDA) having the requested 5G-TAI and the NCGI from the user database (108).

At step (412), the method (400) may include receiving, by the system (104), an AA answer having the 5G-TAI and the NCGI for each of the one or more UEs (102) from the AAA server (106). In an example, the system (104) may receive a Diameter EAP answer to the from the AAA server (106). In an embodiment, the Diameter EAP answer may include the user location.

At step (414), the method (400) includes transmitting, by the system (104), a session creation request to a Session Management Function (SMF) (112), wherein the session creation request includes the NCGI and the 5G-TAI appended to the User Location Information (ULI) Information Element (IE). In an example, the system (104) may send a General Packet Radio Service (GPRS) Tunnelling Protocol v2 (GTPv2) Create Session Request to the SMF (112). In an embodiment, the Create Session Request may include the user location.

At step (416) the method (400) may include transmitting, by the SMF (112), the NCGI and the 5G-TAI to a Policy and Charging Function (PCF) (114). In an example, the 7^{th} bit and the 8^{th} bit of the 4^{th} octet of ULI may store values indicating presence of the NCGI and the 5G-TAI respectively.

At step (418), the method (400) may include receiving, by the SMF (112), one or more policy and charging rules from the PCF (114). In some embodiments, the PCF (114) may determine the one or more policy and charging rules based on the user location.

At step (420), the method (400) includes receiving, by the SMF (112), one or more policy and charging rules determined by the PCF (114) based on the 5G-TAI and the NCGI. The SMF (112) may create a session based on the one or more policy and charging rules. In an example, the SMF (112) may transmit a GTPv2 Create Session Response to the system (104).

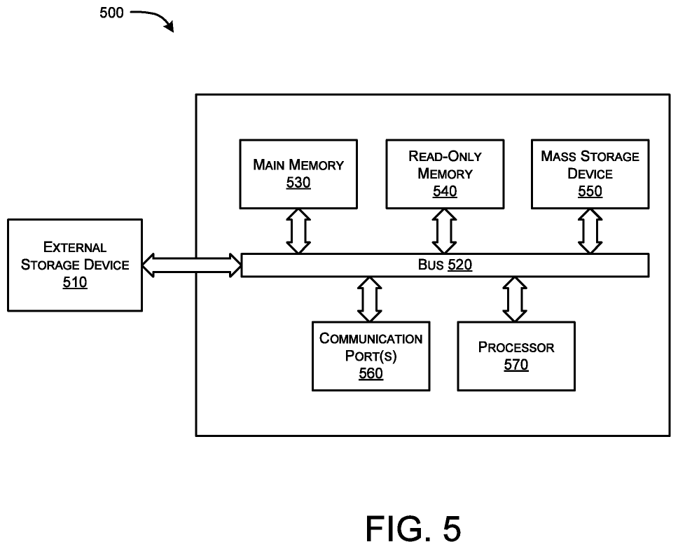

FIG. 5 illustrates an exemplary computer system (500) in which or with which the proposed system may be implemented, in accordance with embodiments of the present disclosure.

As shown in FIG. 5, the computer system (500) may include an external storage device (510), a bus (520), a main memory (530), a read-only memory (540), a mass storage device (550), a communication port(s) (560), and a processor (570). A person skilled in the art will appreciate that the computer system (500) may include more than one processor and communication ports. The communication port(s) (560) may be chosen depending on a network, such as a Local Area Network (LAN), Wide Area Network (WAN), or any network to which the computer system (500) connects. The main memory (530) may be Random Access Memory (RAM), or any other dynamic storage device commonly known in the art. The read-only memory (540) may be any static storage device(s) e.g., but not limited to, a Programmable Read Only Memory (PROM) chip for storing static information e.g., start-up or basic input/output system (BIOS) instructions for the processor (570). The mass storage device (550) may be any current or future mass storage solution, which can be used to store information and/or instructions.

The bus (520) may communicatively couple the processor (570) with the other memory, storage, and communication blocks. Optionally, operator and administrative interfaces, e.g., a display, keyboard, and cursor control device may also be coupled to the bus (520) to support direct operator interaction with the computer system (500). Other operator and administrative interfaces can be provided through network connections connected through the communication port(s) (560). In no way should the aforementioned exemplary computer system (500) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Present Disclosure

The present disclosure provides a system and a method that transmits a New Radio (NR) Cell Global Identifier (NCGI) and Fifth-generation Tracking Area Identity (5G-TAI) to a core network.

The present disclosure provides for a system and a method to transmit user location information using a general packet radio service (GPRS) tunnelling protocol version 2 (GTPv2).

The present disclosure provides for a system and a method to enable an evolved-Packet Data Gateway (ePDG) or Trusted Wireless Local Area Network (WLAN) Access Gateway (TWAN) to provide user location information to Policy Control Function (PCF) via Session Management Function (SMF).

The present disclosure provides for a system and a method to enable PCF to determine policies based on NCGI and 5G-TAI.

The present disclosure provides for a system and a method that allow UEs connected through external networks with services of the core network.

We claim:

1. A system (104) for transmitting user location of User Equipment (UEs) (102) to core network (116), comprising:
one or more processors (202); and
a memory (204) operatively coupled to the one or more processors (202), the memory (204) having one or more processor-executable instructions, which, when executed, cause the one or more processors (202) to:
receive a request from one or more UEs (102) for a service provided by a core network (116), wherein the one or more UEs (102) are connected to the core network (116) via a network entity (118) associated with an external network;
transmit a session creation request to a Session Management Function (SMF) (112), wherein the session creation request comprises a New Radio (NR) Cell Global Identifier (NCGI) and a Fifth-generation Tracking Area Identifier (5G-TAI) appended to a User Location Information (ULI) Information Element (IE) transmitted through the session creation request; and receive a session creation response from the SMF (112) indicating creation of a session, wherein the SMF (112) creates the session for enabling communication between the one or more UEs (102) and the core network (116) via the network entity (118) based on the NCGI and the 5G-TAI.

2. The system (104) as claimed in claim 1, wherein the one or more processors (202) are configured to retrieve the 5G-TAI and the NCGI from an Access Management Function (AMF) (110) of the core network (116).

3. The system (104) as claimed in claim 2, wherein to retrieve the 5G-TAI and the NCGI from the AMF (110), the one or more processors (202) are configured to:
transmit an Authentication and Authorization (AA) request to an Authentication, Authorization and Accounting (AAA) server (106) to request for the 5G-TAI and the NCGI of each of the one or more UEs (102), wherein in response to the AA request, the AAA server (106) transmits a User Data Request (UDR) to a user database server (108) of the core network (116) for requesting the 5G-TAI and the NCGI of each of the one or more UEs (102), and receives a User Data Answer (UDA) having the requested 5G-TAI and the NCGI from the user database server (108), and wherein in response to the UDR, the user database server (108) transmits a network exposure request to the AMF (110), and receives a network exposure response having the 5G-TAI and the NCGI for each of the one or more UEs (102) from the AMF (110); and
receive the 5G-TAI and the NCGI of each of the one or more UEs (102) from the AAA server (106).

4. The system (104) as claimed in claim 1, wherein the SMF (112) creates the session based on one or more policy and charging rules determined to be applicable by a Policy and Charging Function (PCF) (114), and wherein the PCF (114) determines the one or more policy and charging rules based on the 5G-TAI and the NCGI provided by the system (104).

5. A method (400) for transmitting user location of one or more User Equipment (UEs) to core network (116), comprising:
receiving, by a system (104), a request from the one or more UEs (102) for a service provided by a core network (116), wherein the one or more UEs (102) are connected to the core network (116) via a network entity (118) associated with an external network;
transmitting, by the system (104), a session creation request to a Session Management Function (SMF) (112), wherein the session creation request comprises a New Radio (NR) Cell Global Identifier (NCGI) and a Fifth-generation Tracking Area Identifier (5G-TAI) appended to a User Location Information (ULI) Information Element (IE) transmitted through the session creation request; and
receiving, by the system (104), a session creation response from the SMF (112) indicating the creation of a session, wherein the SMF (112) creates the session for enabling communication between the one or more UEs (102) and the core network (116) via the network entity (118) based on the NCGI and the 5G-TAI.

6. The method (400) as claimed in claim 5, comprising retrieving, by the system (104), the 5G-TAI and the NCGI from an Access Management Function (AMF) (110) of the core network (116).

7. The method (400) as claimed in claim 6, wherein for retrieving the 5G-TAI and the NCGI, the method (400) comprises:
transmitting, by the system (104), an Authentication and Authorization (AA) request to an Authentication, Authorization, and Accounting (AAA) server (106), wherein in response to the AA request, the AAA server (106) transmits a User Data Request (UDR) to a user database server (108) of the core network (116) for requesting the 5G-TAI and the NCGI of each of the one or more UEs (102), and receives a User Data Answer (UDA) having the requested 5G-TAI and the NCGI from the user database server (108), and wherein in response to the UDR, the user database server (108) transmits a network exposure request to the AMF (110), and receives a network exposure response having the 5G-TAI and the NCGI of each of the one or more UEs (102) from the AMF (110); and
receiving, by the system (104), an AA answer having the 5G-TAI and the NCGI for each of the one or more UEs (102) from the AAA server (106).

8. The method (400) as claimed in claim 6, wherein the SMF (112) creates the session based on one or more policy and charging rules determined to be applicable by a Policy and Charging Function (PCF) (114), and wherein the PCF (114) determines the one or more policy and charging rules based on the 5G-TAI and the NCGI provided by the system (104).

9. A User Equipment (UE) device (102) comprising:
one or more processors; and
a memory operatively coupled to the one or more processors, the memory having one or more processor-executable instructions, which, when executed, cause the one or more processors to:
transmit, via a network entity (118) associated with an external network, a set of signals to a system (104) for requesting a service provided by a core network (104), wherein on receiving the request, the system (104) is configured to:
transmit a session creation request to a Session Management Function (SMF) (112), wherein the session creation request comprises a New Radio (NR) Cell Global Identifier (NCGI) and a Fifth-generation Tracking Area Identifier (5G-TAI) appended to a User Location Information (ULI) Information Element (IE) transmitted through the session creation request; and
receive a session creation response from the SMF (112) indicating the creation of a session, wherein the SMF (112) creates the session for enabling communication between the one or more UEs (102) and the core network (116) via the network entity (118) based on the NCGI and the 5G-TAI,
wherein the UE (102) uses the session to communicate with the other UEs (102) connected to the core network (116).

10. A non-transitory computer-readable medium comprising processor-executable instructions that cause a processor to:
receive a request from one or more User Equipment (UEs) (102) for a service provided by a core network (116), wherein the UEs (102) connected to the core network (116) via a network entity (118) associated with an external network;
transmit a session creation request to a Session Management Function (SMF) (112), wherein the session creation request comprises a New Radio (NR) Cell Global Identifier (NCGI) and a Fifth-generation Tracking Area Identifier (5G-TAI) appended to a User Location Information (ULI) Information Element (IE) transmitted through the session creation request; and
receive a session creation response from the SMF (112), wherein the SMF (112) creates a session for enabling communication between the one or more UEs (102) and the core network (116) via the network entity (118) based on the NCGI and the 5G-TAI.
